(19) United States
(12) Patent Application Publication
(10) Pub. No.: US 2019/0276731 A1
(43) Pub. Date: Sep. 12, 2019

(54) Diverting Agent For Diversion Acidizing In Water Injection Wells And A Preparation Method Thereof

(71) Applicant: PetroChina Company Limited, Beijing (CN)

(72) Inventors: Lijun Mu, Beijing City (CN); Xianwen Li, Beijing City (CN); Hongjun Lu, Beijing City (CN); Zhiying Deng, Beijing City (CN); Yong Wang, Beijing City (CN); Bin Yao, Beijing City (CN); Zhenning Ji, Beijing City (CN); Suiwang Zhang, Beijing City (CN); Xiaobing Lu, Beijing City (CN); Zhaojie Song, Beijing City (CN); Erzhen Wang, Beijing City (CN); Lei Sui, Beijing City (CN)

(21) Appl. No.: 16/240,107

(22) Filed: Jan. 4, 2019

(30) Foreign Application Priority Data
Mar. 12, 2018 (CN) 2018102000818

(51) Int. Cl. C09K 8/74; C09K 8/66; C09K 8/68

(52) U.S. Cl. CPC C09K 8/74; C09K 8/68; C09K 8/665

(57) ABSTRACT

The present disclosure provides a diverting agent for diversion acidizing in water injection wells and a preparation method thereof. The diverting agent for diversion acidizing in water injection wells has a raw material composition including: 3%-6% of ethylenediamine, 12%-25% of bromododecane, 10%-20% of a solvent, 10%-20% of an assistant, 14%-28% of oleic acid, 5%-10% of stearic acid salt, 1%-2% of a dispersing agent and a balance of water. The present disclosure also provides a method for preparing the above-mentioned diverting agent for diversion acidizing in water injection wells. The diverting agent for diversion acidizing in water injection wells of the present disclosure can be used for temporary plugging diverting of acid solution in on-line acidification of water injection wells or in acidification operation of oil reservoir with a greater heterogeneity, which has good compatibility with the acid solution and can be used for temporary plugging of high-permeability zones.

### RELATED APPLICATIONS

This application claims priority under 35 U.S.C. § 119 or 365 to Chinese Application No. 2018102000818, filed Mar. 12, 2018. The entire teachings of the above application is incorporated herein by reference.

### INVENTION DISCLOSURE

The present disclosure relates to a diverting agent for acid solution, especially, a diverting agent for diversion acidizing in water injection wells, belonging to the field of petroleum exploitation technology.

### BACKGROUND

Due to the incompatibility of the conventional acid solution with the diverting agent, the existing conventional diversion acidizing process is mainly composed of several steps: firstly, tripping, secondly, injecting the acid, thirdly, injecting spacer slug and then injecting the diversion agent or diverting agent, and fourthly, injecting the spacer fluid and then injecting the acid solution for acidification, and the like, and therefore the construction steps are complex and the site operation is difficult. Moreover, in the acidizing process, the particulate temporary plugging and diverting agent such as phenolic resin cannot achieve ideal temporary plugging and diverting effect because of the limitation of its particle size by reservoir pore diameter, and meanwhile, it tends to form filter cakes on the wall of the well, and cannot enter high-permeability pores to achieve the ideal temporary plugging and diverting effect.

Chinese patent application CN104402740A introduced an acidizing and diverting agent used in the temperature range of 40° C-60° C., obtained by using sodium bicarbonate as an assistant and reacting diethanolamine with 1-bromobutane by condensation followed by quaternization of the condensate with bromo-octadecane. This agent has a good adsorbability, can effectively reduce the filtration loss of the acid solution, and break gel automatically when the agent encounters hydrocarbon after acidification; however, this plugging agent is not applied to low permeability and ultralow permeability reservoirs, and the viscosity of the diverting agent with an acid concentration below 4% is not investigated.

In order to solve the deficiency of the existing diversion acidizing technology used in the heterogeneous sandstone reservoir in oil fields, there is an urgent need to study the acidizing technology suitable for actual situation of acidizing construction in heterogeneous sandstone reservoir.

### SUMMARY

To solve the above-mentioned technical problem, an object of the present disclosure is to provide an acid solution temporary plugging and diverting agent used in on-line acidification of water injection wells or acidizing operation in reservoirs having a great heterogeneity, which has a good compatibility with the acid solution and can be used for temporary plugging in the high-permeability zones.

To achieve the above-mentioned technical object, the present disclosure provides a diverting agent for diversion acidizing in water injection wells. With respect to 100 wt % of the total mass of the diverting agent for diversion acidizing in water injection wells, the diverting agent for diversion acidizing in water injection wells has a raw material composition including: 3%-6% of ethylenediamine, 12%-25% of bromododecane, 10%-20% of a solvent, 10%-20% of an assistant, 14%-28% of oleic acid, 5%-10% of stearic acid salt, 1%-2% of a dispersing agent and a balance of water, wherein the sum of mass percentages of each raw material in the diverting agent for diversion acidizing in water injection wells is 100%.

According to a specific embodiment of the present disclosure, ethylenediamine, bromododecane and oleic acid are analytical pure and are used in the amide reaction as raw materials for the synthesis of secondary amines and tertiary amines.

In the diverting agent of the present disclosure, the solvent is used to dissolve a solute such as solid, liquid, or gas to become a solution. Preferably, the solvent as used is anhydrous ethanol.

In the diverting agent of the present disclosure, the assistant as used is used to adjust pH value and improve the reaction rate. Preferably, the assistant as used is sodium hydroxide solution.

In the diverting agent of the present disclosure, preferably, the assistant as used is sodium hydroxide solution with a mass concentration of 10%-15%; more preferably, the assistant as used is sodium hydroxide solution with a mass concentration of 10%.

In the diverting agent of the present disclosure, the stearic acid as used is used as an enhancer to improve the viscosity and thermal stability of the solution. Preferably, the stearic acid salt as used is glycolamide stearate or glycerol monoisostearate, more preferably, the stearic acid salt as used is glycolamide stearate.

In the diverting agent of the present disclosure, the dispersing agent as used is used to ensure the uniform dispersion of each component in the solution. Preferably, the dispersing agent as used is sodium dodecyl sulfate or sodium dodecylbenzene sulfonate; more preferably, the dispersing agent as used is sodium dodecyl sulfate.

With respect to 100 wt % of the total mass of the diverting agent for diversion acidizing in water injection wells, the diverting agent for diversion acidizing in water injection wells has a raw material composition including: 3%-6% of ethylenediamine, 12%-25% of bromododecane, 10%-20% of anhydrous ethanol, 10%-20% of sodium hydroxide solution (with a mass concentration of 10%), 14%-28% of oleic acid, 5%-10% of glycolamide stearate, 1%-2% of sodium dodecyl sulfate and a balance of water, wherein the sum of mass percentages of each raw material in the diverting agent for diversion acidizing in water injection wells is 100%.

The diverting agent for diversion acidizing in water injection wells of the present disclosure can be used for temporary plugging and diverting of acid solution in on-line acidification of water injection wells or acidizing operation in reservoirs having a great heterogeneity, and can be added directly into a chelating acid for use, with an added amount of the diverting acid of 8.0%-12%.

The present disclosure also provides a method for preparing the diverting agent for diversion acidizing in water injection wells, including the following steps:

Step 1, mixing ethylenediamine, and bromododecane with an amount of the solvent and reacting for 6-7 hours (preferably 6 hours);

Step 2, adding dropwise the assistant after the addition of oleic acid and reacting for 9-10 hours (preferably 10m hours), at this time the solution having a pH of 7-8;

Step 3, adding the remaining solvent while adding dropwise stearic acid salt and the dispersing agent, reflux for 7-8 hours to obtain the diverting agent for diversion acidizing in water injection wells;

wherein the solvent is added in two portions; 40%-50% of the total mass of the solvent is added in Step 1, and the remaining 50%-60% of the solvent is added in Step 3.

In the above-mentioned preparation method, preferably, Steps 1-3 are carried out at 90-100° C. and the reaction temperatures of Steps 1-3 are the same.

In the above-mentioned preparation method, preferably, in Step 2, the assistant is added dropwise with a rate of 11.0%-12.5% of the total amount of the assistant per hour.

In the above-mentioned preparation method, preferably, in Step 3, the stearic acid salt and the dispersing agent are added dropwise with a rate of 14.0%-16.5% of the total amount of stearic acid salt and the dispersing agent per hour.

Specifically, the above preparation method includes the following steps:

Step 1, mixing ethylenediamine, and bromododecane with an amount of the solvent at 90-100° C. and reacting under reflux for 6 hours;

Step 2, slowly adding dropwise the assistant after the addition of oleic acid at 90° C-100° C. and reacting under reflux for 10 hours, keeping the pH of the solution at 7-8;

Step 3, at 90° C-100° C., adding the remaining solvent and adding dropwise stearic acid salt, and the dispersing agent, reacting under reflux for 8 hours to obtain the diverting agent for diversion acidizing in water injection wells.

The diverting agent for diversion acidizing in water injection wells according to the present disclosure has a good compatibility with the chelating acid, and can directly enter low permeability reservoirs along with the acid solution to temporarily plugging high-permeability zones, thus simplifying the construction process and formulating an acid solution for acidification which is suitable for low permeability oil field.

The diverting agent for diversion acidizing in water injection wells according to the present disclosure can be used for acidification and chemical profile control of water wells in oil gas field.

The diverting agent for diversion acidizing in water injection wells according to the present disclosure has a good compatibility with the acid solution, thus improving the retardance of the solution. When the diverting agent for diversion acidizing in water injection wells according to the present disclosure is mixed with the acid solution, the diversion of the acid solution can efficiently reduce the damage to reservoirs caused by water sensitivity and salt sensitivity in low permeability reservoirs, prevent the residual acid from reacting with the formation minerals to form secondary precipitates, and achieve no flowback of the residual acid. When mixed with the acid solution, the diverting agent for diversion acidizing in water injection wells according to the present disclosure can enter deep zones of the low permeability reservoirs, thus plugging the high-permeability zones and removing plugging from the low-permeability zones.

The raw materials of the diverting agent for diversion acidizing in water injection wells according to the present disclosure are simple and easily available.

When the diverting agent for diversion acidizing in water injection wells according to the present disclosure enters the formation, as the concentration of the acid solution decreases, a temporary plugging is formed due to the increase of viscosity of the diverting agent itself, which causes the subsequent acid solution to enter the low-permeability layer to remove plugging. At the later stage, as the added amount of the acid solution decreases, the network structure is destroyed and the viscosity is reduced, and thus the temporary plugging performance is removed to ensure normal injection of water wells.

### BRIEF DESCRIPTION OF THE DRAWING

The Figure shows a curve of the change in injection pressure ratio in Example 5.

### DETAILED DESCRIPTION

In order to more clearly understand the technical features, purposes and beneficial effects of the present disclosure, now the technical solutions of the present disclosure will be described in detail below, but it should not be understood as limiting the implementable scope of the present disclosure.

### EXAMPLE 1

The present example provides a diverting agent for diversion acidizing in water injection wells, with respect to 100 wt % of the total mass of the diverting agent for diversion acidizing in water injection wells, the diverting agent for diversion acidizing in water injection wells has a raw material composition of: 6% of ethylenediamine, 25% of bromododecane, 20% of anhydrous ethanol, 20% of sodium hydroxide solution with a mass concentration of 10%, 28% of oleic acid, 10% of sodium glycolamide stearate, 2% of sodium dodecyl sulfate and a balance of water;

Ethylenediamine, bromododecane and oleic acid as used are analytical pure.

The present example also provides a method for preparing the diverting agent for diversion acidizing in water injection wells, specifically including the following steps:

Step 1, mixing ethylenediamine, and bromododecane with an amount of solvent (40% of the total mass of the solvent) at 100° C. and reacting under reflux for 6 hours;

Step 2, slowly adding dropwise the assistant (with a rate of 11.0%-12.5% of the total amount of the assistant per hour) after the addition of oleic acid at 100° C. and reacting under reflux for 9 hours, keeping the pH of the solution at 7-8;

Step 3, at 100° C., adding the solvent (60% of the total mass of the solvent) and at the same time adding dropwise the stearic acid salt, and the dispersing agent (with a rate of 14.0%-16.5% of the total amount of the stearic acid salt and the dispersing agent per hour), reacting under reflux for 7 hours to obtain the diverting agent for diversion acidizing in water injection wells.

The effect of the diverting agent on the retardance of the chelating acid, as measured by experiments, is shown in Table 1. The chelating acid is mainly obtained by mixing hydrochloric acid, ammonium fluoride, chelating agent, corrosion inhibitor, anti-swelling/swelled-clay-shrinking agent and water in a mass ratio of 8:2:3:1:1:18. The diverting agent for diversion acidizing in water injection wells in Example 1 is used as the diverting agent, and the chelating acid is mixed with the diverting agent in a ratio of 9:1. The mixing ratio of the acid solution, and of the acid solution to the diverting agent is the same in the following Examples.

It can be known from Table 1 that the diverting agent can effectively reduce the acid-rock reaction rate of the chelating acid.

TABLE 1
the effect of the diverting agent on the
retardance of the chelating acid

| | Reaction | Corrosion | Reaction | Corrosion |
|---|---|---|---|---|
| | time | rate | time | rate |
| Acid solution | (min) | (%) | (min) | (%) |
| Chelating acid | 5 | 8 | 20 | 20 |
| without diverting | | | | |
| agent | | | | |
| Chelating acid with | 5 | 3 | 20 | 14 |
| diverting agent | | | | |

### EXAMPLE 2

The present example provides a diverting agent for diversion acidizing in water injection wells. With respect to 100 wt % of the total mass of the diverting agent for diversion acidizing in water injection wells, the diverting agent for diversion acidizing in water injection wells has a raw material composition of: 3% of ethylenediamine, 12% of bromododecane, 10% of anhydrous ethanol, 10% of sodium hydroxide solution with a mass concentration of 10%, 14% of oleic acid, 5% of sodium glycolamide stearate, 1% of sodium dodecyl sulfate and a balance of water.

The present example also provides a method for preparing the diverting agent for diversion acidizing in water injection wells, specifically including the following steps:

Step 1, mixing ethylenediamine, and bromododecane with an amount of solvent (40% of the total mass of the solvent) at 90° C. and reacting under reflux for 6 hours;

Step 2, slowly adding dropwise the assistant (with a rate of 11.0%-12.5% of the total amount of the assistant per hour) after the addition of oleic acid at 90° C. and reacting under reflux for 10 hours, keeping the pH of the solution at 7-8;

Step 3, at 90° C., adding the solvent (60% of the total mass of the solvent) and at the same time adding dropwise the stearic acid salt, and the dispersing agent (with a rate of 14.0%-16.5% of the total amount of the stearic acid salt and the dispersing agent per hour), reacting under reflux for 8 hours to obtain the diverting agent for diversion acidizing in water injection wells.

The effect of the diverting agent on the retardance of the chelating acid, as measured by experiments, is shown in Table 2. The diverting agent can effectively reduce the acid-rock reaction rate of the chelating acid.

TABLE 2
the effect of the diverting agent on the
retardance of the chelating acid

| | Reaction | Corrosion | Reaction | Corrosion |
|---|---|---|---|---|
| | time | rate | time | rate |
| Acid solution | (min) | (%) | (min) | (%) |
| Chelating acid | 5 | 7 | 20 | 18 |
| without diverting | | | | |
| agent | | | | |
| Chelating acid with | 5 | 2 | 20 | 12 |
| diverting agent | | | | |

### EXAMPLE 3

The present example provides a diverting agent for diversion acidizing in water injection wells. With respect to 100 wt % of the total mass of the diverting agent for diversion acidizing in water injection wells, the diverting agent for diversion acidizing in water injection wells has a raw material composition of: 4% of ethylenediamine, 16% of bromododecane, 13% of anhydrous ethanol, 13% of sodium hydroxide solution with a mass concentration of 10%, 18% of oleic acid, 6% of sodium glycolamide stearate, 1.3% of sodium dodecyl sulfate and a balance of water.

The present example also provides a method for preparing the diverting agent for diversion acidizing in water injection wells, specifically including the following steps:

Step 1, mixing ethylenediamine, and bromododecane with an amount of solvent (40% of the total mass of the solvent) at 90° C. and reacting under reflux for 7 hours;

Step 2, slowly adding dropwise the assistant (with a rate of 11.0%-12.5% of the total amount of the assistant per hour) after the addition of oleic acid at 90° C. and reacting under reflux for 10 hours, keeping the pH of the solution at 7-8;

Step 3, at 90° C., adding the solvent (60% of the total mass of the solvent) and at the same time adding dropwise the stearic acid salt, and the dispersing agent (with a rate of 14.0%-16.5% of the total amount of the stearic acid salt and the dispersing agent per hour), reacting under reflux for 8 hours to obtain the diverting agent for diversion acidizing in water injection wells.

The effect of the diverting agent on the viscosity of the chelating acid, as measured by experiments is shown in Table 3. When the concentration of the chelating acid is 20%, the viscosity of the mixture of the diverting agent and the chelating acid is 20 mPa·s, and the mixture can be injected into the formation; when the concentration of the chelating acid is 10%, the viscosity of the mixture of the diverting agent and the chelating acid is 125 mPa·s, ensuring the acid diversion of the chelating acid; when the concentration of the acid decreases to 1%, the viscosity of the mixture of the diverting agent and the chelating acid is 3 mPa·s, the acid solution is in a state of complete gel breaking, and the temporary plugging state is completely removed, providing a basis for no flowback of the diverting agent.

TABLE 3
the effect of the diverting agent on the viscosity of the chelating acid

| | Concentration of the | Viscosity | Concentration of the | Viscosity | Concentration of the | Viscosity |
|---|---|---|---|---|---|---|
| Acid solution | chelating acid (%) | (mPa · s) | chelating acid (%) | (mPa · s) | chelating acid (%) | (mPa · s) |
| Chelating acid | 20 | 1.8 | 10 | 1.5 | 1 | 1 |
| without diverting | | | | | | |
| agent | | | | | | |
| Chelating acid | 20 | 20 | 10 | 125 | 1 | 3 |
| with diverting | | | | | | |
| agent | | | | | | |

### EXAMPLE 4

The present example provides a diverting agent for diversion acidizing in water injection wells. With respect to 100 wt % of the total mass of the diverting agent for diversion acidizing in water injection wells, the diverting agent for diversion acidizing in water injection wells has a raw material composition of: 5% of ethylenediamine, 20% of bromododecane, 16% of anhydrous ethanol, 16% of sodium hydroxide solution (with a mass concentration of 10%), 24% of oleic acid, 8% of sodium glycolamide stearate, 1.6% of sodium dodecyl sulfate and a balance of water.

The present example also provides a method for preparing the diverting agent for diversion acidizing in water injection wells, specifically including the following steps:

Step 1, mixing ethylenediamine, and bromododecane with an amount of solvent (40% of the total mass of the solvent) at 100° C. and reacting under reflux for 6 hours;

Step 2, slowly adding dropwise the assistant (with a rate of 11.0%-12.5% of the total amount of the assistant per hour) after the addition of oleic acid at 100° C. and reacting under reflux for 9 hours, keeping the pH of the solution at 7-8;

Step 3, at 100° C., adding the solvent (60% of the total mass of the solvent) and at the same time adding dropwise the stearic acid salt, and the dispersing agent (with a rate of 14.0%-16.5% of the total amount of the stearic acid salt and the dispersing agent per hour), reacting under reflux for 7 hours to obtain the diverting agent for diversion acidizing in water injection wells.

The effect of the diverting agent on the viscosity of the chelating acid, as measured by experiments, is shown in Table 4. When the concentration of the chelating acid is 20%, the viscosity of the mixture of the diverting agent and the chelating acid is 20 mPa·s, and the mixture can be injected into formation; when the concentration of the chelating acid is 10%, the viscosity of the mixture of the diverting agent and the chelating acid is 119 mPa·s, ensuring the acid diversion of the chelating acid; when the concentration of the acid decreases to 1%, the viscosity of the mixture of the diverting agent and the chelating acid is 3 mPa·s, the acid solution is in a state of complete gel breaking, and the temporary plugging state is completely removed, providing a basis for no flowback of the diverting agent.

TABLE 4
the effect of the diverting agent on the viscosity of the chelating acid

| | Concentration of the | Viscosity | Concentration of the | Viscosity | Concentration of the | Viscosity |
|---|---|---|---|---|---|---|
| Acid solution | chelating acid (%) | (mPa · s) | chelating acid (%) | (mPa · s) | chelating acid (%) | (mPa · s) |
| Chelating acid | 20 | 1.8 | 10 | 1.5 | 1 | 1 |
| without diverting | | | | | | |
| agent | | | | | | |
| Chelating acid | 20 | 20 | 10 | 119 | 1 | 3 |
| with diverting | | | | | | |
| agent | | | | | | |

### EXAMPLE 5

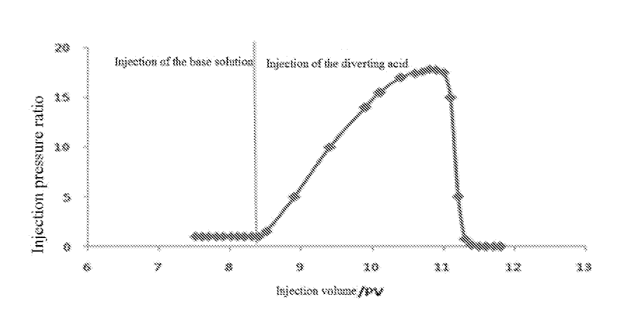

In the present Example, the chelating acid is used as a diverting acid, the diverting agent for diversion acidizing in water injection wells in Example 1 is used as the diverting agent, and the same cored well selected from low permeability reservoirs in Changqing Oilfield is used as the experimental core, which has a gas permeability of 25.2 mD and 26.5 mD, and a porosity of 12.4% and 12.7%, respectively. The dimensionless pressure factor is used as the standard for the diversion ability of the diverting acid. The results are shown in Table 5 and FIG. 1.

TABLE 5
Acid injection experimental data

| | | Total | Maximum | |
|---|---|---|---|---|
| | Total | acid | acid | |
| | pore | injection | injection | |
| | volume | amount | pressure | Dimensionless |
| Acid type | mL | mL | MPa | pressure factor |
| Conventional | 11.85 | 3.03 | 4.5 | 1 |
| acid | | | | |
| Diverting acid | 11.49 | 5.45 | 17.8 | 3.955 |

It can be seen from Table 5 that when the acid injection pressure of the conventional acid is used as the standard, the dimensionless pressure factor of the diverting acid is about 4 times that of the conventional acid, and the amount of the diverting acid used in the experiment is 1.6-1.8 times that of the conventional acid; that is, the diverting agent playing a role of diverting in the core.

Meanwhile, it can be seen from FIG. 1 that during the injection of the base solution (KCl solution with a mass concentration of 2%), the pressure change is small; during the injection of the diverting acid, the injection pressure ratio continues to rise and substantially maintains stable for a period of time, which indicates that the diverting agent can play a role of temporary plugging the spacerslug in the acidizing process, force the acid solution into the low-permeability layer and remove the plugging of reservoirs caused by water sensitivity, salt sensitivity, inorganic scale, etc., showing that the diverting agent has a good diversion ability.

1. A diverting agent for diversion acidizing in water injection wells, which is characterized in that with respect to 100 wt % of the total mass of the diverting agent for diversion acidizing in water injection wells, the diverting agent for diversion acidizing in water injection wells has a raw material composition comprising: 3%-6% of ethylenediamine, 12%-25% of bromododecane, 10%-20% of a solvent, 10%-20% of an assistant, 14%-28% of oleic acid, 5%-10% of stearic acid salt, 1%-2% of a dispersing agent and a balance of water, wherein the sum of mass percentages of each raw material in the diverting agent for diversion acidizing in water injection wells is 100%.

2. The diverting agent for diversion acidizing in water injection wells according to claim 1, wherein the solvent is anhydrous ethanol.

3. The diverting agent for diversion acidizing in water injection wells according to claim 1, wherein the assistant is sodium hydroxide solution.

4. The diverting agent for diversion acidizing in water injection wells according to claim 1, wherein the assistant is sodium hydroxide solution with a mass concentration of 10%-15%.

5. The diverting agent for diversion acidizing in water injection wells according to claim 4, wherein the assistant is sodium hydroxide solution with a mass concentration of 10%.

6. The diverting agent for diversion acidizing in water injection wells according to claim 1, wherein the stearic acid salt is glycolamide stearate or glycerol monoisostearate.

7. The diverting agent for diversion acidizing in water injection wells according to claim 6, wherein the stearic acid salt is glycolamide stearate.

8. The diverting agent for diversion acidizing in water injection wells according to claim 1, wherein the dispersing agent is sodium dodecyl sulfate or sodium dodecylbenzene sulfonate.

9. The diverting agent for diversion acidizing in water injection wells according to claim 8, wherein the dispersing agent is sodium dodecyl sulfate.

10. A method for preparing the diverting agent for diversion acidizing in water injection wells according to claim 1, the method comprising:
a) mixing ethylenediamine, and bromododecane with an amount of the solvent and reacting under reflux for 6-7 hours;
b) adding dropwise the assistant after the addition of oleic acid, and reacting under reflux for 9-10 hours; and
c) adding the remaining solvent and at the same time adding dropwise stearic acid salt, and the dispersing agent, reacting under reflux for 7-8 hours to obtain the diverting agent for diversion acidizing in water injection wells;
wherein the solvent is added in two portions; 40%-50% of the total mass of the solvent is added in a), and the remaining 50%-60% of the solvent is added in c).

11. The method according to claim 10, wherein a)-c) are carried out at 90-100° C.

12. The method according to claim 10, wherein in b), the assistant is added dropwise at a rate of 11.0%-12.5% of the total amount of the assistant per hour.

13. The method according to claim 10, wherein in c), the stearic acid salt and the dispersing agent are added dropwise at a rate of 14.0%-16.5% of the total amount of stearic acid salt and the dispersing agent per hour.
